(19) United States
(12) Patent Application Publication
(10) Pub. No.: US 2009/0134645 A1
(43) Pub. Date: May 28, 2009

(54) TWEEZERS

(75) Inventors: ZHI-FENG DONG, Foshan (CN); YING LIU, Foshan (CN)

Correspondence Address: PCE INDUSTRY, INC.;ATT. Steven Reiss, 458 E. LAMBERT ROAD, FULLERTON, CA, 92835, US

(73) Assignees: PREMIER IMAGE TECHNOLOGY(CHINA) LTD., Foshan City (CN); HON HAI PRECISION INDUSTRY CO., LTD., Tu-Cheng (TW)

(21) Appl. No.: 12/118,953

(22) Filed: May 12, 2008

(30) Foreign Application Priority Data
Nov. 23, 2007 (CN) 200710202655.7

(51) Int. Cl. G04D 1/02; B25B 7/00

(52) U.S. Cl. 294/99.2

(57) ABSTRACT

A tweezer includes two symmetrical levers attached at one fixed end thereof. Each lever has a connecting section connected to a holding section, which is connected to an end section extending therefrom in that order. A distance between the two connecting sections gradually decreases towards the holding sections. A distance between the two end sections gradually increases away from the holding sections.

### TECHNICAL FIELD

The present invention relates to tweezers, and more particularly, to tweezers for holding glued elements.

### DESCRIPTION OF RELATED ART

Tweezers are used to hold and manipulate various objects that are inconvenient to handle with human hands. Referring to FIG. 5, FIG. 5 is a planar and schematic view of a conventional tweezer 200 according to a related art. The tweezer 200 typically includes two levers 210 attached at one fixed end 220 (the fulcrum point of each lever 210). The two levers 210 have two opposite free ends 230. The free ends 230 have flat tips 231 for cooperatively picking up and holding an object. When using the tweezer 200 to hold a glued camera module 150 with glue 151, the flat tips 231 are easily stained by the glue 151 on the camera module 150, and then may contaminate other objects held thereby.

Therefore, it is desirable to provide tweezers, which can overcome the above-mentioned problem.

### SUMMARY

A tweezer includes two symmetrical levers attached at one fixed end thereof. Each lever has a connecting section connected to a holding section, which is connected to an end section extending therefrom in that order. A distance between the two connecting sections gradually decreases towards the holding sections. A distance between the two end sections gradually increases away from the holding sections.

### BRIEF DESCRIPTION OF THE DRAWING

Many aspects of the present tweezers can be better understood with reference to the following drawings. The components in the drawings are not necessarily drawn to scale, the emphasis instead being placed upon clearly illustrating the principles of the present tweezers.

FIG. 1 is a planar and schematic view of a tweezer in using status including a curved gripping portion according to a first exemplary embodiment.

FIG. 2 is an enlarged view of the curved gripping portion according to the first exemplary embodiment.

FIG. 3 is an enlarged view of the curved gripping portion according to a second exemplary embodiment.

FIG. 4 is an enlarged view of the curved gripping portion according to a third exemplary embodiment.

FIG. 5 is a planar and schematic view of a tweezers according to a related art.

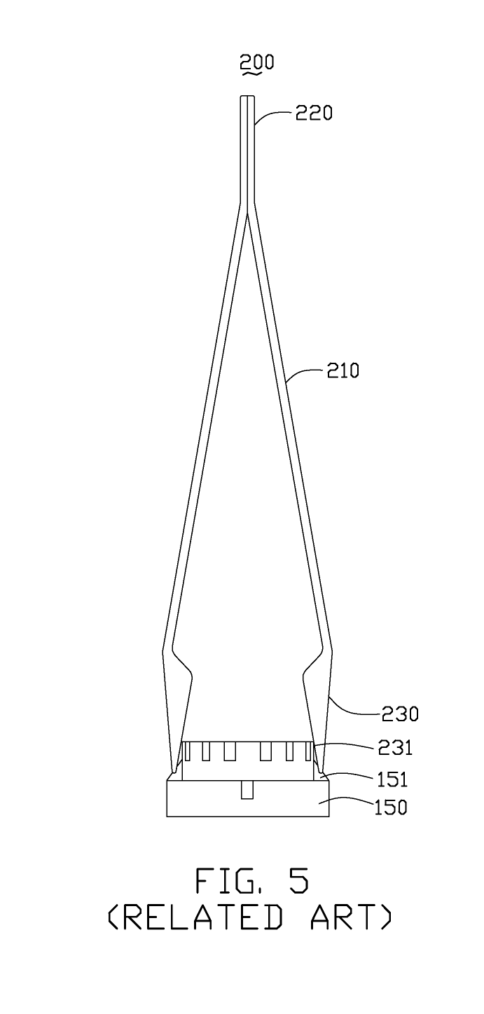

### DETAILED DESCRIPTION OF THE EMBODIMENTS

Embodiments of the present invention will now be described in detail below, with reference to the drawings.

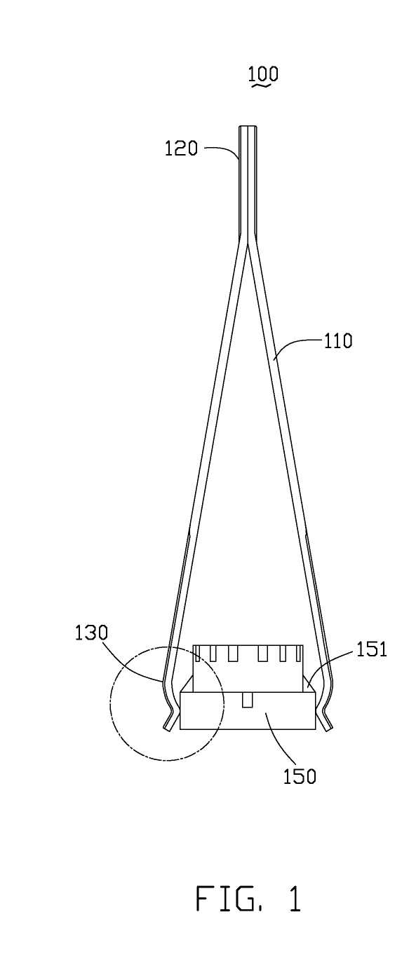

Referring to FIG. 1, FIG. 1 is a planar and schematic view of a tweezers 100 in using status according to a first exemplary embodiment. The tweezers 100 for holding an object such as a camera module 150 with glue 151 includes two symmetrical levers 110 attached at one fixed end 120 thereof. Each of the levers 110 has a curved gripping portion 130 formed near the distal end of the lever 110.

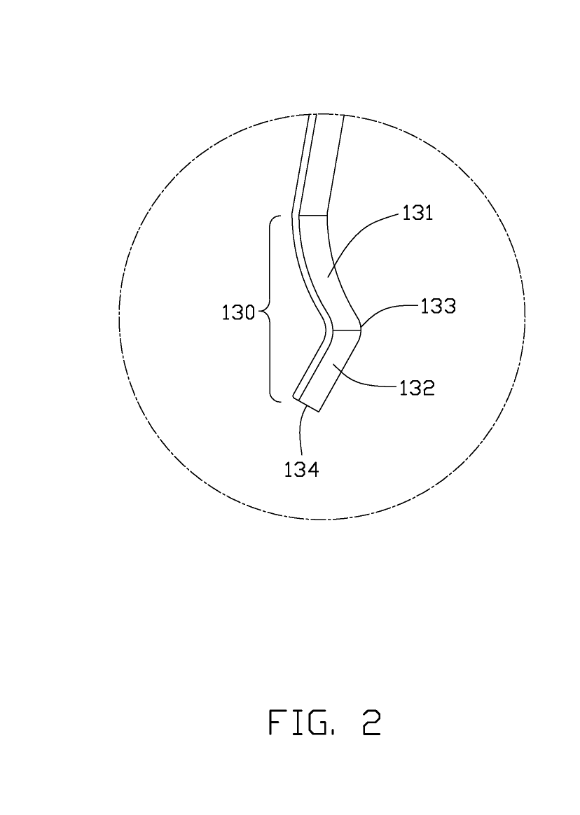

Also referring to FIG. 2, FIG. 2 is an enlarged view of the curved gripping portion 130 according to the first exemplary embodiment. One of the curved gripping portions 130 is enlarged and shown within the dotted lines of FIG. 1. The curved gripping portion 130 includes a connecting section 131, an end section 132, and a holding section 133. The connecting section 131 is connected to the end section 132. The holding section 133 is the intersection of the connecting section 131 and the end section 132.

The connecting sections 131 are symmetrically faced inwards. A distance between the two connecting sections 131 gradually decreases towards the holding sections 133.

The end sections 132, which are connected to the connecting sections 131, face an opposite direction relative to the connecting sections 131 and are diverged from each other. The end sections 132 respectively further include free ends 134. A distance between the free ends 134 is larger than a distance between the holding sections 133 in order to prevent the free ends 134 from being stained by the glue 151 on the camera modules 150 when picking up the glued camera modules 150 with the tweezers 100.

The holding sections 133 are protruding points facing inwards towards each other and are configured for holding the glued camera modules 150.

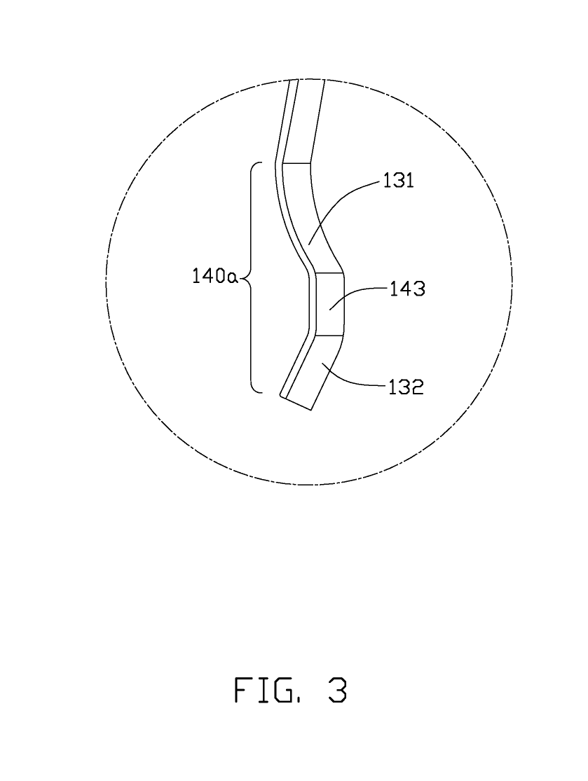

Referring to FIG. 3, FIG. 3 is an enlarged view of a curved gripping portion 140a according to a second exemplary embodiment. One of the curved gripping portions 140a is shown within the dotted lines of FIG. 1 according to a second exemplary embodiment. The curved gripping portions 140a are similar to the curved gripping portions 130 of the first embodiment except for a holding section 143. The difference between the first embodiment and the second embodiment is that the holding section 143 connected between the connecting section 131 and the end section 132 is flat in order to provide a large contact area to firmly hold the object. The two holding sections 143 are parallel to each other substantially. A distance between the two connecting sections 131 gradually decreases towards the holding sections 143. A distance between the two end sections 132 gradually increases away from the holding sections 143. Other aspects of the second embodiment are substantially the same as that of the first embodiment, and are not described in detail.

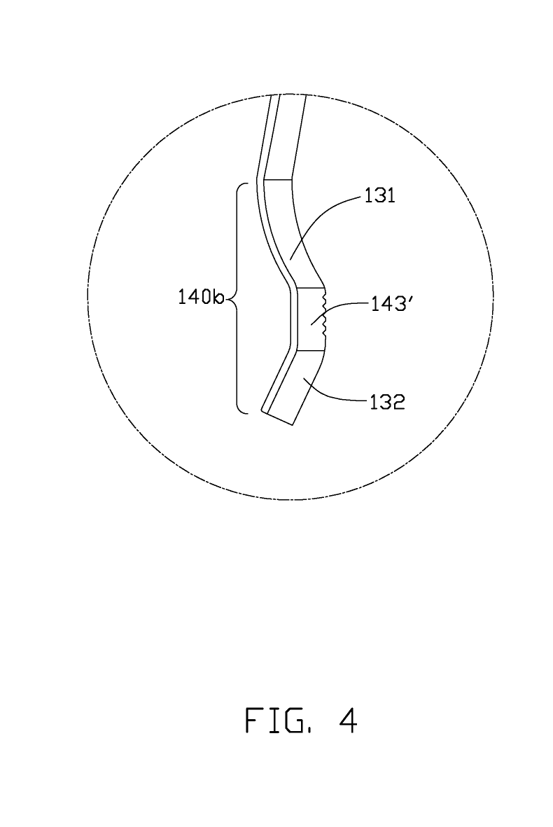

Referring to FIG. 4, FIG. 4 is an enlarged view of a curved gripping portion 140b according to a third exemplary embodiment. One of the curved gripping portions 140b is shown within the dotted lines of FIG. 1 according to a third exemplary embodiment. The curved gripping portions 140b are similar to the curved gripping portions 140a of the second embodiment except for a holding section 143′. The difference between the first embodiment and the second embodiment is that the holding section 143′ connected between the connecting section 131 and the end section 132 has a saw surface and configured for providing more contact areas and frictional force in order to easily hold the object. Other aspects of the third embodiment are substantially the same as that of the second embodiment, and are not described in detail.

While certain embodiments have been described and exemplified above, various other embodiments will be apparent to those skilled in the art from the foregoing disclosure. The present invention is not limited to the particular embodiments described and exemplified but is capable of considerable variation and modification without departure from the scope of the appended claims.

What is claimed is:

1. A tweezers, comprising:
two symmetrical levers attached at one fixed end, each lever comprising a connecting section, a holding section connected to the connecting section, and an end section extending from the holding section, a distance between the two connecting sections being gradually decreasing towards the holding sections, and a distance between the two end sections being gradually increasing away from the holding sections.

2. The tweezers as claimed in claim 1, wherein the end sections further comprise free ends respectively and a distance between the free ends is larger than a distance between the holding sections.

3. The tweezers as claimed in claim 1, wherein the holding sections are protruding tips facing inwards to each other.

4. The tweezers as claimed in claim 1, wherein the holding sections are flat contact faces respectively.

5. The tweezers as claimed in claim 4, wherein the holding sections are parallel to each other substantially.

6. The tweezers as claimed in claim 1, wherein the holding sections comprise saw contact faces respectively.
